(19) United States
(12) Patent Application Publication
(10) Pub. No.: US 2025/0230512 A1
(43) Pub. Date: Jul. 17, 2025

(54) ARRANGEMENT AND PROCESS FOR CHARGING IRON ORE TO, AND/OR DISCHARGING SPONGE IRON FROM, A DIRECT REDUCTION SHAFT

(71) Applicant: HYBRIT Development AB, Stockholm (SE)

(72) Inventors: Mikael Lindvall, Luleå (SE); Sten Ångström, Stockholm (SE)

(21) Appl. No.: 18/881,584

(22) PCT Filed: Feb. 21, 2023
(86) PCT No.: PCT/SE2023/050156

§ 371 Date: Jan. 6, 2025

(30) Foreign Application Priority Data
Jul. 7, 2022 (SE) 2250864-2

(51) Int. Cl. C21B 13/02; C21B 13/00

(52) U.S. Cl. CPC C21B 13/02; C21B 13/004; C21B 13/0073; C21B 2100/64

(57) ABSTRACT

An arrangement and process for charging iron ore to a direct reduction shaft, as well as an arrangement and process for discharging sponge iron from a direct reduction shaft. The processes each include the steps of evacuating gas from a vessel by application of vacuum followed by refilling the vessel with a process gas from the direct reduction shaft. Also provided is a system for the production of sponge iron including such an arrangement for charging iron ore and/or discharging sponge iron. Further provided is a process for direct reduction of iron ore, wherein the process includes introducing a process gas from direct reduction to a direct reduction shaft in conjunction with charging iron ore and/or in discharging sponge iron.

### TECHNICAL FIELD

The present invention relates to an arrangement for charging iron ore to a direct reduction shaft, as well as a process for charging iron ore to a direct reduction shaft utilizing such an arrangement. The invention further relates to an arrangement for discharging sponge iron from a direct reduction shaft, as well as a process for discharging sponge iron from a direct reduction shaft utilizing such an arrangement. Moreover, the invention relates to a system for the production of sponge iron comprising such arrangements, and a process for direct reduction of iron ore.

### BACKGROUND ART

Steel is the world's most important engineering and construction material. It is difficult to find any object in the modern world that does not contain steel, or depend on steel for its manufacture and/or transport. In this manner, steel is intricately involved in almost every aspect of our modern lives.

In 2018, the total global production of crude steel was 1 810 million tonnes, by far exceeding any other metal, and is expected to reach 2 800 million tonnes in 2050 of which 50% is expected to originate from virgin iron sources. Steel is also the world's most recycled material with a very high recycling grade due to the metals' ability to be used over and over again after remelting, using electricity as the primary energy source.

Thus, steel is a cornerstone of modern society with an even more significant role to play in the future.

Steel is mainly produced via three routes:
i) Integrated production using virgin iron ores in a blast furnace (BF), where iron oxide in the ore is reduced by carbon to produce iron. The iron is further processed in the steel plant by oxygen blowing in a basic oxygen furnace (BOF), followed by refining to produce steel. This process is commonly also referred to as ‘oxygen steelmaking’.
ii) Scrap-based production using recycled steel, which is melted in an electric arc furnace (EAF) using electricity as the primary source of energy. This process is commonly also referred to as ‘electric steelmaking’.
iii) Direct reduction production based on virgin iron ore, which is reduced in a direct reduction (DR) process with a carbonaceous reducing gas to produce sponge iron. The sponge iron is subsequently melted together with scrap in an EAF to produce steel.

The term crude iron is used herein to denote all irons produced for further processing to steel, regardless of whether they are obtained from a blast furnace (i.e., pig iron), or a direct reduction shaft (i.e., sponge iron).

Although the above-named processes have been refined over decades and are approaching the theoretical minimum energy consumption, there is one fundamental issue not yet resolved. Reduction of iron ore using carbonaceous reductants results in the production of CO₂ as a by-product. For every ton steel produced in 2018, an average of 1.83 tonnes of CO₂ were produced. The steel industry is one of the highest CO₂-emitting industries, accounting for approximately 7% of CO₂ emissions globally. Excessive CO₂-generation cannot be avoided within the steel production process as long as carbonaceous reductants are used.

The HYBRIT initiative has been founded to address this issue. HYBRIT, short for HYdrogen BReakthrough Ironmaking Technology—is a joint venture between SSAB, LKAB and Vattenfall, funded in part by the Swedish Energy Agency, and aims to reduce CO₂ emissions and de-carbonize the steel industry.

Central to the HYBRIT concept is a direct reduction based production of sponge iron from virgin ore. However, instead of using carbonaceous reductant gases, such as natural gas, as in present commercial direct reduction processes, HYBRIT proposes using hydrogen gas as the reductant, termed hydrogen direct reduction (H-DR). The hydrogen gas may be produced by electrolysis of water using mainly fossil-free and/or renewable primary energy sources, as is the case for e.g., Swedish electricity production. Thus, the critical step of reducing the iron ore may be achieved without requiring fossil fuel as an input, and with water as a by-product instead of CO₂.

In prior art fossil-based direct reduction systems, as well as in the proposed hydrogen-based direct reduction systems, it is imperative that iron ore may be charged safely to the direct reduction shaft. Since the process gases passing through the shaft are highly combustible (typically comprising hydrogen, carbon monoxide and hydrocarbons in the fossil-based process), it is essential that formation of explosive air/process gas mixtures is avoided when introducing ore to the shaft. This is typically achieved by ensuring that only an inert (i.e., inflammable non-oxidant) seal gas, and not air, is introduced to the shaft when charging ore, and that no process gas escapes the shaft uncontrolled via the charging arrangement. Exactly how this is achieved depends on the design of the direct reduction system.

Typically, in DR shafts operating at low pressure (e.g., ≤2 bar), such as the Midrex process, a dynamic gas seal is arranged at a seal leg connecting an ore charge charging vessel to the direct reduction shaft. Inert seal gas is introduced at a pressure exceeding the operating pressure of the DR shaft at one or more points in the seal leg. This higher-pressure seal gas prevents air from being introduced into the DR shaft with the iron ore charge, as well as preventing process gas from escaping the DR shaft through the seal leg.

Typically, in DR shafts operating at higher pressures (e.g., >2 bar), such as the Hyl ZR process, a charging vessel is arranged at the inlet to the direct reduction shaft. Ore is charged to the pressurizable charging vessel, which is first flushed with an inert seal gas to exclude air, then pressurized to a pressure greater than the operating pressure of the DR shaft using the seal gas. Once pressurized, the valve separating the charging vessel and DR shaft is opened to allow the iron ore charge to be introduced to the shaft, together with seal gas. Typically, multiple charging vessels are arranged in parallel to supply ore to the DR shaft.

Similar arrangements are also typically located at the discharge end of the direct reduction shaft in order to safely discharge the sponge iron produced.

There remains a need for improved means of charging iron ore to, and/or discharging sponge iron from, a direct reduction shaft.

### SUMMARY OF THE INVENTION

The inventors of the present invention have identified a number of shortcomings with prior art means of charging iron ore to a direct reduction shaft.

Prior art means of charging ore typically require the use of large volumes of seal gas. Seal gas is typically produced on-site, using for example an air separator unit when the seal gas is nitrogen. The large volume of seal gas required leads to increased capital and operating expenses for the direct reduction system.

Additionally, seal gas is inevitably introduced into the process gas using prior art ore charging means. As described above, the seal gases typically used, such as nitrogen, must be inert (i.e., not form explosive mixtures with process gas), and therefore are retained in the process gas. However, the other components of the process gas are typically either consumed by reaction (e.g., H₂, CO, CH₄) or removed from circulation (e.g., H₂O, CO₂). This means that seal gas gradually accumulates in the process gas and would comprise an ever-increasing proportion if no action is taken. In order to avoid such a situation, a proportion of the process gas is typically bled from the process gas circuit and flared in order to maintain a suitable concentration of inert components in the process gas. This is economically deleterious, in particular for proposed hydrogen-based direct reduction processes since the reducing gas in such a case is expected, at least initially, to be more expensive than fossil-based reducing gases. If the reducing gas is fossil-based, bleeding the process gas is also of negative environmental consequence as it leads to increased CO₂ emissions.

The outlet of the direct reduction shaft, wherefrom the produced sponge iron is discharged, also requires sealing, and prior art means of discharging sponge iron suffer from the same disadvantages as prior art means of charging ore.

It would be advantageous to achieve a means for charging iron ore to a direct reduction shaft and/or discharging sponge iron from a direct reduction shaft that overcomes, or at least alleviates, at least some of the above-mentioned shortcomings. In particular, it would be desirable to enable a means for charging iron ore to a direct reduction shaft and/or discharging sponge iron from a direct reduction shaft that decreases the need for seal gas and potentially avoids the need to bleed process gas, thus potentially decreasing the operating expenses of the direct reduction plant.

To better address one or more of these concerns, a process for charging iron ore to a direct reduction shaft having the features defined in the independent claim is provided.

The process comprises the steps:
a) setting an ore outlet of an ore charging vessel in a sealed state;
b) setting an ore inlet of the ore charging vessel in an open state;
c) charging the ore charging vessel with iron ore via the ore inlet;
d) setting the ore inlet in a sealed state;
e) evacuating gas from the ore charging vessel by application of vacuum;
f) refilling the ore charging vessel with process gas from the direct reduction shaft; and
g) setting the ore outlet in an open state to charge iron ore to the direct reduction shaft.

According to the disclosed process, the ore-filled charging vessel is evacuated by application of a vacuum before refilling with process gas from the direct reduction shaft, via a gas transfer conduit linking the direct reduction shaft or a process gas circuit thereof to the ore charging vessel. Since the application of vacuum removes substantially all air from the charging vessel, this allows the vessel to be filled directly with process gas from the direct reduction shaft, and flushing of the charging vessel with multiple volumes of seal gas to secure removal of oxygen is not required. This may be compared to the volumes of seal gas used to flush the charging vessel in prior art methods, which is typically about 5 times the volume of the charging vessel per charge. Moreover, since the vessel is refilled with process gas from the direct reduction shaft, no inert gas is introduced to the process gases upon charging the ore to the shaft, and therefore there is less accumulation of inert gas in the direct reduction process gas, and less need for flaring.

By process gas from the direct reduction shaft, it is meant process gas taken from the direct reduction shaft or process gas taken form a process gas circuit of the direct reduction shaft. If taken from a process gas circuit, the process gas is preferably taken from a point in the process gas circuit prior to mixing of spent process gas with makeup gas.

According to another aspect of the present invention, the objects of the invention are attained by a process for discharging sponge iron from a direct reduction shaft according to the appended independent claim.

The process for discharging sponge iron comprises the steps:
i) setting an iron outlet and an iron inlet of an iron discharging vessel in a sealed state;
ii) evacuating gas from the iron discharging vessel by application of vacuum;
iii) refilling the iron charging vessel with process gas from the direct reduction shaft;
iv) setting an iron inlet of the iron discharging vessel in an open state;
v) charging the iron discharging vessel with sponge iron via the iron inlet; and
vi) setting the iron inlet in a sealed state.

In a similar manner as for the process for charging iron ore, the use of vacuum removes substantially all air from the discharging vessel, meaning that it may be refilled using process gas from the direct reduction shaft without risk of forming explosive mixtures. Thus, when the vessel is opened to the direct reduction shaft to discharge sponge iron, no dilution of the process gases occurs.

The following considerations are independently applicable both to the process for charging iron ore, and to the process for discharging sponge iron, unless it is specifically indicated otherwise.

Vacuum may be applied to bring the ore charging vessel (and alternatively, or in addition, to the iron discharging vessel) to a pressure of about 100 mbar or less, preferably about 10 mbar or less, even more preferably about 1 mbar or less, at normal temperature (20° C.). The use of a relatively strong vacuum leads to sufficient evacuation of air (oxidant) from the vessel and avoids formation of explosive mixtures when refilling with process gas (reductant) from the direct reduction shaft.

The process may further comprise steps of removing gas from the ore charging vessel (and alternatively, or in addition, from the iron discharging vessel) by application of vacuum; and refilling the vessel with an inert gas. These steps may be performed after the step d) of setting the ore inlet in a sealed state, but prior to step e) of evacuating gas from the ore charging vessel by application of vacuum (or after step i, but prior to step ii in the process for discharging sponge iron). That is to say that an additional vacuum evacuation/refill cycle may be performed. This means that even if a relatively poor vacuum is used, such as greater than about 100 mbar, the process may be performed stagewise by first performing an initial vacuum evacuation/refill cycle to provide a gas mixture in the vessel comprising mostly of the inert gas, but with some remaining air. The subsequent vacuum evacuation/refill cycle should suffice to provide a gas mixture in the vessel comprising essentially of the process gas from the direct reduction shaft for the purpose of the invention (i.e., avoiding the formation of potentially explosive gas/air mixtures).

Of course, multiple vacuum evacuation/refill cycles may be performed as necessary, such as a total of three or four vacuum evacuation/refill cycles, instead of the single and double vacuum evacuation/refill cycles already described. However, the total quantity of inert gas required in the process increases with each vacuum evacuation/refill cycle performed, and therefore preferably as few vacuum evacuation/refill cycles as possible are used. Where more than one vacuum evacuation/refill cycles are preformed, refill in the initial cycle(s) is performed using inert gas, and refill using the process gas from the direct reduction shaft is performed only in the final refill step.

The inert gas may be selected from the list consisting of carbon dioxide, nitrogen, purified flue gas, and combinations thereof. The carbon dioxide may be derived from a biological source, i.e., non-fossil CO₂.

Specifically the process for charging iron ore to a direct reduction shaft may comprise further steps of setting the ore outlet in a sealed state; removing a process gas from the ore charging vessel by venting and/or application of vacuum; refilling the ore charging vessel with a gas selected from air, inert gas, and combinations thereof; and setting the ore inlet in an open state. The inert gas may be selected from carbon dioxide, nitrogen, purified flue gas, and combinations thereof. In this manner, the charging vessel may be prepared for introduction of a further charge of iron ore whilst ensuring an effective use of gases.

According to another aspect of the invention, the objects of the invention are achieved by a process for direct reduction of iron ore to sponge iron according to the appended independent claim. The process comprises introducing process gas from direct reduction to a direct reduction shaft in conjunction with charging the iron ore to the direct reduction shaft and/or in conjunction with discharging a sponge iron from the direct reduction shaft. By “in conjunction with charging the iron ore to the direct reduction shaft” it is meant that the process gas from direct reduction is introduced together with the iron ore being charged to the shaft. By “in conjunction with discharging sponge iron from the direct reduction shaft” it is meant that the process gas from direct reduction is introduced from the discharge vessel when this vessel is opened to permit discharge of sponge iron from the shaft. By “introducing [ . . . ] in conjunction with”, it is meant that the gas may for example be introduced to the direct reduction shaft using the processes for charging iron ore to a direct reduction shaft and/or discharging sponge iron from the direct reduction shaft as described herein and in the appended independent claims.

Since a gas is unavoidably introduced to the direct reduction shaft in conjunction with charging and/or discharging of solids to the direct reduction shaft, by introducing such gases that reduce and/or optionally carburize the iron ore, the process introduces only gases serving a purpose in the direct reduction and avoids introducing gases that may have a deleterious effect on the process. Gases that may have a deleterious effect on the process are for example inert gases such as nitrogen that may accumulate in the process gas and decrease the reducing capacity of the process gas if allowed to accumulate to excessive concentrations. Normally, bleeding of process gas is necessary to ameliorate the effects of such accumulation. Therefore, the disclosed process permits a more effective use of process gas and thus may decrease operating expenses of the process.

The process may comprise introducing make-up gas into the direct reduction shaft in counter current flow to the iron ore. The make-up gas is selected from hydrogen, methane (such as natural gas or biomethane) and syngas (such as bio-syngas). This make-up gas may ensure that sufficient reducing gas is introduced to the process to sufficiently reduce the iron ore to sponge iron.

According to a further aspect of the invention, the objects of the invention are achieved by an arrangement for charging iron ore to a direct reduction shaft according to the appended independent claim. The arrangement for charging iron ore comprises:
an ore charging vessel;
a direct reduction shaft; and
a source of vacuum.

The source of vacuum is arranged in controllable fluid communication with the ore charging vessel.

The ore charging vessel is arranged in controllable fluid communication with the direct reduction shaft via a gas transfer conduit arranged to extend between the direct reduction shaft or a process gas circuit thereof and the ore charging vessel. The gas transfer conduit may for example extend from an upper section of the direct reduction shaft, for example in proximity to a top gas outlet of the direct reduction shaft.

Such an arrangement facilities performing the process for charging iron ore to a direct reduction shaft as described herein and in the appended independent claim. The ore charging vessel, or more specifically the ore outlet of the ore charging vessel, is typically arranged in communication with an inlet of the direct reduction shaft, allowing ore to pass from the ore charging vessel to the direct reduction shaft.

According to yet a further aspect of the invention, the objects of the invention are achieved by an arrangement for discharging sponge iron from a direct reduction shaft according to the appended independent claim.

The arrangement for discharging sponge iron comprises:
a sponge iron discharging vessel;
a direct reduction shaft; and
a source of vacuum.

The source of vacuum is arranged in controllable fluid communication with the iron discharging vessel.

The sponge iron discharging vessel is arranged in controllable fluid communication with the direct reduction shaft via a gas transfer conduit arranged to extend between the direct reduction shaft or a process gas circuit thereof and the sponge iron discharging vessel.

Such an arrangement facilities performing the process for discharging sponge iron from a direct reduction shaft as described herein and in the appended independent claim. The iron discharging vessel, or more specifically the iron inlet of the iron discharging vessel, is typically arranged in communication with an outlet of the direct reduction shaft, allowing sponge iron to pass from the direct reduction shaft to the iron discharging vessel.

The following considerations are independently applicable both to the arrangement for charging iron ore, and to the arrangement for discharging sponge iron, unless it is specifically indicated otherwise.

The ore charging vessel may comprise a sealable ore inlet and a sealable ore outlet. The gas transfer conduit may comprise a controllable valve. The iron discharging vessel may comprise a sealable iron inlet and a sealable iron outlet. The gas transfer conduit may comprise a controllable valve. The source of vacuum and/or a source of the seal gas may be arranged in fluid communication with the gas transfer conduit.

The arrangement(s) may further comprise a source of an inert gas. The source of the inert gas may be arranged in controllable fluid communication with the ore charging vessel and/or with the iron discharging vessel.

If the arrangement(s) further comprises a source of an inert gas, then the inert gas may be selected from the list consisting of carbon dioxide, nitrogen, purified flue gas, and combinations thereof. The carbon dioxide may be derived from a biological source, i.e., non-fossil CO₂.

The arrangement(s) may be configured to attain a pressure of about 100 mbar or less at normal temperature (20° C.) in the ore charging vessel (and alternatively, or in addition in the iron discharging vessel), preferably about 10 mbar or less, even more preferably about 1 mbar or less. This may require that:
the source of vacuum is sufficiently strong to bring the vessel to the desired pressure, and/or
the vessel is configured to tolerate such a low pressure (i.e., the vessel may be a vacuum vessel), and/or
any openings in the vessel such as the sealable inlet, sealable outlet and/or gas conduit(s) are sealable to an such an extent that they may permit the source of vacuum to maintain such a pressure in the vessel.

According to yet another aspect of the invention, the objects of the invention are achieved by a system for the production of sponge iron according to the appended independent claim. The system comprises an arrangement for charging iron ore as described herein, and/or an arrangement for discharging sponge iron as described herein. That is to say that the system comprises an arrangement for charging iron ore as described herein; or an arrangement for discharging sponge iron as described herein; or an arrangement for charging iron ore and an arrangement for discharging sponge iron as described herein. The system may further comprise a charging arrangement and/or discharging arrangement as conventionally known in the art. The system further comprises a source of make-up gas arranged in fluid communication with the direct reduction shaft. If the system comprises an arrangement for charging iron ore, the ore charging vessel may be arranged in communication with an inlet of the direct reduction shaft. If the system comprises an arrangement for discharging sponge iron, the iron discharging vessel may be arranged in communication with an outlet of the direct reduction shaft. If the system comprises both an arrangement for charging iron ore and an arrangement for discharging sponge iron, the system may require only a single source of vacuum and optionally a single source of inert gas. That is to say that separate gas and/or vacuum sources are not necessarily required for the charging and discharging arrangements, and that one or more of these sources may be consolidated.

The source of make-up gas may be an electrolyser. The electrolyser may produce hydrogen by water electrolysis, or syngas (a mixture of carbon monoxide and hydrogen) by co-electrolysis of water and carbon dioxide. The make-up gas therefore may be hydrogen or syngas, such as bio-syngas. In this manner, it is possible to produce sponge iron without requiring the use of fossil fuels as the source of reducing gas.

Further objects, advantages and novel features of the present invention will become apparent to one skilled in the art from the following detailed description.

### BRIEF DESCRIPTION OF THE DRAWINGS

For a fuller understanding of the present invention and further objects and advantages of it, the detailed description set out below should be read together with the accompanying drawings, in which the same reference notations denote similar items in the various diagrams, and in which:

FIG. 1 schematically illustrates an ore-based steelmaking value chain according to the Hybrit concept;

FIG. 2 schematically illustrates an exemplifying embodiment of a system suitable for performing a process as disclosed herein;

FIG. 3 is a flow chart schematically illustrating an exemplifying embodiment of a process for charging iron ore as disclosed herein; and

FIG. 4 is a flow chart schematically illustrating an exemplifying embodiment of a process for discharging sponge iron as disclosed herein.

### DETAILED DESCRIPTION

The present invention is based upon an insight by the inventors that, when charging iron ore to a direct reduction shaft, removal of air from the charging vessel using vacuum followed by refilling with process gas from the direct reduction shaft (e.g., top gas), or a process gas circuit thereof, provides a wide range of potential advantages. The use of an inert seal gas is avoided, since, in contrast with prior art methods that are based upon dilution of the atmosphere inside the charging vessel (corresponding to multiple “vessel volumes” of seal gas that needs to be flushed) until the atmosphere is sufficiently inert, the presently disclosed process first removes the air atmosphere and replaces it with process gas from the direct reduction shaft. Since no inert seal gas is introduced into the direct reduction shaft, accumulation of inert gases in the process gas may be avoided, and the need for bleeding of process gas may be decreased or avoided completely.

The same concept may be applied when discharging sponge iron from the direct reduction shaft, and the same or similar advantages are obtained.

The term process gas is used herein to denote the gas mixture in the direct reduction process, regardless of stage in the process. That is to say that process gas refers to gas that is introduced to, passes through, leaves, and is recycled back to the direct reduction shaft. By process gas circuit of the direct reduction shaft it is meant the series of gas lines that convey spent process gas from the direct reduction shaft, via a series or treatments such as dedusting, heat exchange, compression, and mixing with makeup gas, back to a point of re-entry into the direct reduction shaft. More specific terms are used to denote the process gas at various points in the process, or to denote component gases added to the process gas to form part of the process gas.

Reducing gas is a gas introduced at a point lower than the inlet of the shaft, and which flows upwards counter to the moving bed of ore in order to reduce the ore and optionally carburize the sponge iron.

Top gas is partially spent process gas that is removed from an upper end of the shaft, in proximity to the ore inlet. After treatment, the top gas may be recycled back to the direct reduction shaft as a component of the reducing gas.

Make-up gas is fresh gas added to the process gas in order to maintain reducing ability. Typically, make-up gas is added to recycled top gas prior to re-introduction into the direct reduction shaft. Thus, the reducing gas typically comprises make-up gas together with recycled top gas. The make-up gas and recycled top gas may be mixed together prior to introduction into the direct reduction shaft, or may be introduced separately and mixed in the shaft.

Seal gas is gas entering the direct reduction shaft from the ore charging arrangement at the inlet of the direct reduction shaft. The outlet end of the direct reduction shaft may also be sealed using a seal gas, and seal gas therefore may enter the DR shaft from a discharging arrangement at the outlet of the direct reduction shaft. Variations of the present invention are therefore equally applicable using seal gas introduced during discharge of sponge iron from the direct reduction shaft. Seal gas as used in prior art processes is typically an inert gas. The present disclosure is based upon the concept of using process gas from the direct reduction shaft as seal gas (i.e., instead of an inert seal gas).

Inert gas is gas that does not form potentially flammable or explosive mixtures with either air or process gas, i.e., a gas that may not act as an oxidant or fuel in a combustion reaction under the conditions prevailing in the process.

By “process gas from the direct reduction shaft or a process gas circuit thereof” it is meant process gas that is sourced internally from the direct reduction shaft, or process gas that is sourced from a process gas circuit of the direct reduction shaft, such as a reducing gas circuit, or cooling gas (carburization) circuit. Process gas sourced internally from the direct reduction shaft may for example be top gas removed from an upper section of the direct reduction shaft, or cooling gas removed from a lower cone section of the direct reduction shaft. If a process gas is used from the process gas circuit, this is preferably a process gas taken from a point in a process gas circuit prior to mixing with makeup gas. That is to say that the process gas sourced from the process gas circuit is preferably purely “recycled” process gas. Henceforth in this application the term “process gas from the direct reduction shaft” in relation to gas used for filling the charging and/or discharging vessels is intended to encompass process gas from the direct reduction shaft or process gas from a process gas circuit of the direct reduction shaft, unless explicitly stated otherwise.

### Charging of Iron Ore

The iron ore burden typically consists predominantly of iron ore pellets, although some lump iron ore may also be introduced. The iron ore pellets typically comprise mostly hematite, together with further additives or impurities such as gangue, fluxes and binders. However, the pellets may comprise some other metals and other ores such as magnetite. Iron ore pellets specified for direct reduction processes are commercially available, and such pellets may be used in the present process.

The ore charging vessel typically is a vessel comprising a sealable ore inlet, a sealable ore outlet, and at least one gas conduit suitable for the evacuation and/or introduction of gases. Naturally, the vessel may comprise multiple gas conduits, for example separate conduits for evacuation and introduction of gas, or multiple conduits for introduction of a variety of gases. The ore charging vessel is suitably constructed to be able to withstand the pressures to which it is subjected: both the sub-atmospheric pressure (c:a 100 mbar or less, preferably c:a 10 mbar or less) prevailing in the evacuation steps and the supra-atmospheric pressure ensuing due to refilling with seal gas (often greater than 2 bar, such as from about 2 bar to about 10 bar). A plurality of ore charging vessels may be arranged in parallel to supply ore to a single direct reductions shaft. For example, two, three, four, five, six, seven, eight, nine or ten ore charging vessels may be arranged to supply a single direct reduction shaft with ore.

Prior to charging ore to the charging vessel, the ore outlet is set in a sealed state in order to be able to contain the ore to be introduced. By “set in a state” it is meant that a component is put into the relevant state if not already in such as state, or maintained in the state if already in such a state. Therefore, the term “set in a state” does not necessarily involve a change of state. Ore is charged to the vessel via the inlet, and the inlet is then sealed. A source of vacuum arranged in fluid communication with a gas conduit is then used to evacuate the atmosphere from the charging vessel. The source of vacuum may for example be a vacuum pump. Such pumps are known in the art. Preferably, the charging vessel and pump are configured such that the charging vessel may be brought to a pressure of pressure of about 100 mbar or less, preferably about 10 mbar or less, even more preferably about 1 mbar or less, at normal temperature (20° C.). Thus, substantially all air is evacuated from the charging vessel. If the vacuum achievable in the evacuation stage is sufficiently low, the charging vessel may subsequently be refilled directly with process gas from the direct reduction shaft.

The process gas may be provided via a gas transfer conduit connecting the direct reduction shaft to the charging vessel. Since the gas transfer line provides a direct fluid communication between the charging vessel and direct reduction shaft, the pressure obtained in the charging vessel is equal to the pressure prevailing in the direct reduction shaft, provided that the gas transfer conduit is held open for a sufficient period of time. Alternatively, the process gas may be provided from a point in the process gas circuit having a pressure equal to or higher than the pressure prevailing in the direct reduction shaft. For example, the gas transfer line may extend from a point arranged an outlet of a compressor arranged in the process gas circuit. In such a case, the pressure obtained in the charging circuit will be in excess of the pressure in the direct reduction shaft.

If the vacuum achievable in the evacuation stage is not sufficiently low, undesired amounts of air may be retained in the charging vessel. In such a case, the charging vessel may initially be refilled with an inert gas, followed by a further evacuation step. In this manner, the amount of air remaining may be lowered to safe levels. The steps of evacuating and refilling with an inert gas may be performed as many times as required in order to ensure safety. In the final refilling step, the charging vessel is filled with the process gas from the direct reduction shaft that will be reintroduced into the direct reduction shaft upon charging. Once filled with ore and process gas, the ore outlet of the charging vessel is set in an open state in order to allow the mixture of ore and process gas to be charged to the direct reduction shaft.

Once ore has been charged to the direct reduction shaft, the ore charging vessel should be reset to safely remove any process gases contained in the vessel and to prepare the vessel for a new charge of ore. This may be done by sealing the ore outlet, evacuating the charging vessel by venting, flushing with inert gas, and/or using vacuum in order to remove process gas, and then subsequently refilling the charging vessel with a suitable gas such as air, nitrogen, purified flue gas, or carbon dioxide. The process gases evacuated in this step may be recycled to the direct reduction shaft. The vessel is refilled to a pressure about atmospheric pressure. When the potentially flammable contents of the vessel have been evacuated and the vessel is once again at atmospheric pressure or thereabouts, the inlet of the vessel may be opened to allow a new charge of iron to be received.

### Direct Reduction

The direct reduction shaft may be of any kind commonly known in the art. By shaft, it is meant a solid-gas counter current moving bed reactor, whereby a burden of iron ore is charged at an inlet at the top of the reactor and descends by gravity towards an outlet arranged at the bottom of the reactor. Reducing gas is introduced at a lower point I the shaft than the ore inlet, and the reducing gas flows upward to reduce and optionally carburize the iron ore.

Reduction is typically performed at temperatures of from about 900° C. to about 1100° C. The temperatures required are typically maintained by pre-heating of the process gases introduced into the reactor, for example using a preheater such as an electric preheater. Further heating of the gases may be obtained after leaving the pre-heater and prior to introduction into the reactor by exothermic partial oxidation of the gases with oxygen or air. Reduction may be performed at a pressure of from about 1 bar to about 10 bar in the DR shaft, preferably from about 3 bar to about 8 bar.

In conventional direct reduction processes, the make-up gas used to replenish the process gas is fossil-based and typically comprises syngas and natural gas in varying proportions. The present disclosure is applicable to processes utilizing such fossil-based make-up gas. However, preferably the make-up gas is not derived from fossil fuels in order to provide a fossil-free process for obtaining sponge iron.

The make-up gas may be composed mainly of hydrogen. For example, the make-up gas may comprise, consist essentially of, or consist of at least 80 vol %, preferably greater than 90 vol %, even more preferably greater than 95 vol % hydrogen gas (vol % determined at normal conditions of 1 atm and 0° C.). The disclosed process permits the production of essentially carbon-free sponge iron by using hydrogen as the make-up gas and not introducing carbonaceous gases into the process gas. However, in some cases it may be desirable to obtain a carburized sponge iron. Therefore, in order to achieve suitable levels of carburization of the sponge iron, some amounts of carburizing gas and/or carbon dioxide may be added as make-up gas. Carburizing gases are carbon-containing gases that are capable of directly carburizing the sponge iron, e.g., all non-fully oxidised carbon compounds, such as hydrocarbons or carbon monoxide. Such gases include, but are not limited to, methane, biogas, syngas, and mixtures thereof. However, a carburizing effect in the present process may alternatively or in addition be achieved by introduction of carbon dioxide. Under the prevailing carbon-lean conditions of the direct reduction shaft, the carbon dioxide may be converted to carbon monoxide and subsequently carburize the sponge iron. The methane may be biomethane and/or the syngas may be bio-syngas. The carbon dioxide may be derived from a biological source, i.e., non-fossil CO₂.

Besides hydrogen, the balance of the make-up gas may therefore comprise, consist essentially of, or consist of carbon dioxide and/or carburizing gas. If carbon dioxide and/or carburizing gas constitute part of the make-up gas these may be introduced to the direct reduction shaft together with the hydrogen make-up gas. Alternatively, a proportion or all of the carbon dioxide and/or carburizing gas constituting part of the make-up gas may be added to the direct reduction shaft separately from the main volume of make-up gas. For example, a carburizing gas may be added to a carburizing or cooling zone of the direct reduction shaft.

The process gas may be at least partially recycled, whereby top (spent) gas from the DR shaft may be cleaned and treated to remove by-products such as water and/or dust prior to re-introduction to the DR shaft. This recycled top gas may be mixed with fresh make-up gas prior to reintroduction into the reactor, or may be introduced separately from any fresh make-up gas supply.

Since in the present disclosed process no inert gas is added to the process gas, bleeding/flaring of the process gas may be decreased or avoided, in contrast to prior art processes. The need for production of inert gas as seal gas is also deceased, and capital equipment such as an air separation unit may be downsized or avoided completely.

Sponge iron is obtained as the product of reduction of the iron ore, and is discharged from the outlet at the bottom end of the direct reduction shaft. The shaft may have a cooling and discharge cone arranged at the bottom to allow the sponge iron to cool prior to discharge from the outlet.

### Discharging Sponge Iron

Discharging sponge iron from the direct reduction shaft has similar requirements as to charging iron ore to the shaft. It is essential when discharging that no combustible/explosive gas mixtures are formed, and it is preferable to avoid introduction of inert gases into the process gas insofar as possible. Therefore, the principles of the present invention may also be applied to a sponge iron discharging apparatus and process.

The iron discharging vessel typically is a vessel comprising a sealable iron inlet, a sealable iron outlet, and at least one gas conduit suitable for the evacuation and/or introduction of gases. Naturally, the vessel may comprise multiple gas conduits, for example separate conduits for evacuation and introduction of gas, or multiple conduits for introduction of a variety of gases. The iron discharging vessel is suitably constructed to be able to withstand the pressures to which it is subjected: both the sub-atmospheric pressure (c:a 100 mbar or less, preferably c:a 10 mbar or less) prevailing in the evacuation steps and the supra-atmospheric pressure ensuing due to refilling with process gas (often greater than 2 bar, such as from about 2 bar to about 10 bar). A plurality of iron discharging vessels may be arranged in parallel to receive iron from a single direct reductions shaft. For example, two, three, four, five, six, seven, eight, nine, or ten ore discharging vessels may be arranged to discharge the iron from a single direct reduction shaft.

Prior to discharging iron to the discharging vessel, the iron inlet and outlet are set in a sealed state. A source of vacuum arranged in fluid communication with a gas conduit is used to evacuate the atmosphere from the discharging vessel. The source of vacuum may for example be a vacuum pump. Such pumps are known in the art. Preferably, the discharging vessel and pump are configured such that the discharging vessel may be brought to a pressure of pressure of about 100 mbar or less, preferably about 10 mbar or less, even more preferably about 1 mbar or less, at normal temperature (20° C.). Thus, substantially all air is evacuated from the discharging vessel. If the vacuum achievable in the evacuation stage is sufficiently low, the discharging vessel may subsequently be refilled with the process gas from the direct reduction shaft to the pressure prevailing in the direct reduction shaft. If the vacuum achievable in the evacuation stage is not sufficiently low, undesired amounts of air may be retained in the discharging vessel. In such a case, the discharging vessel may initially be refilled with an inert gas, followed by a further evacuation step. In this manner, the amount of air remaining may be lowered to safe levels. The steps of evacuating and refilling with an inert gas may be performed as many times as required in order to ensure safety. In the final refilling step, the discharging vessel is filled with the process gas that will be introduced into the direct reduction shaft upon discharging of sponge iron. Once a suitable atmosphere is established inside of the discharging vessel, the iron inlet may be opened to allow sponge iron to be received in the vessel from the direct reduction shaft. Once loaded with sponge iron, the inlet of the discharging vessel may be closed. The closed vessel then comprises a mixture of hot sponge iron and process gases. Preferably, the gaseous contents of the vessel should once again be removed by flushing with inert gas, venting the vessel, and/or application of vacuum and replaced with an inert gas at a suitable pressure before opening the outlet of the discharging vessel to release the contained sponge iron. The process gases evacuated in this step may be recycled to the direct reduction shaft.

### Sponge Iron

The term crude iron is used herein to denote all irons produced for further processing to steel, regardless of whether they are obtained from a blast furnace (i.e., pig iron), or, as in the disclosed process, a direct reduction shaft (i.e., sponge iron). The sponge iron obtained at the outlet of the DR shaft is typically predominantly in the form of pellets, due to the structural integrity of the direct reduction pellets, as well as the conditions prevailing in the DR shaft. Such sponge iron is typically referred to as direct reduced iron (DRI). Depending on the process parameters, it may be provided as hot (HDRI) or cold (CDRI). Cold DRI may also be known as Type (B) DRI. DRI may be prone to re-oxidation and in some cases is pyrophoric. However, there are a number of known means of passivating the DRI. One such passivating means commonly used to facilitate overseas transport of the product is to press the hot DRI into briquettes. Such briquettes are commonly termed hot briquetted iron (HBI), and may also be known as type (A) DRI.

The sponge iron product obtained by the process herein may be an essentially fully metallized sponge iron, i.e., a sponge iron having a degree of reduction (DoR) greater than about 90%, such as greater than about 94% or greater than about 96%. Degree of reduction is defined as the amount of oxygen removed from the iron oxide, expressed as a percentage of the initial amount of oxygen present in the iron oxide. It is often not commercially favourable to obtain sponge irons having a DoR greater than about 96% due to reaction kinetics, although such sponge irons may be produced if desired.

As described above, the process described herein is suitable for producing either carbon-free or carburized sponge iron, as desired. By carburized sponge iron it is meant carbon-containing sponge iron. The carbon present in the sponge iron product may typically be in the form of cementite (Fe3C) and/or graphite. Graphite tends to dust and to be lost from the sponge iron prior to reaching the melt of the EAF. For this reason, it may be preferable if carbon is present in the sponge iron as cementite.

The carburized sponge iron may comprise from 0.1 to 5 percent carbon by weight, such as from 0.5 to 3 percent carbon by weight such as about 1 to 2 percent carbon by weight. It is typically desirable for further processing that the sponge iron has a carbon content of from 0.5 to 5 percent carbon by weight, preferably from 1 to 4 percent by weight, such as about 3 percent by weight, although this may depend on the ratio of sponge iron to scrap used in a subsequent EAF processing step. If desired, the carburized sponge iron product of the present process may subsequently be further carburized by other means prior to further processing.

### Gases

Hydrogen gas may preferably be obtained at least in part by electrolysis of water. If the water electrolysis is performed using renewable energy then this allows the provision of a reducing gas from renewable sources. The electrolytic hydrogen may be conveyed by a conduit directly from the electrolyser to the DR shaft, or the hydrogen may be stored upon production and conveyed to the DR shaft as required.

If carbon dioxide is used in the process described herein, either as make-up gas or inert gas, it is preferable that the source of carbon dioxide is essentially pure carbon dioxide, e.g., 95 vol % carbon dioxide or greater, preferably 98 vol % or greater. The source of carbon dioxide may preferably be from a high-concentration source, preferably a high-concentration biogenic source. For example, concentrated “green” CO₂ may be obtained as a by-product of bio-gas production by anaerobic digestion, or as a by-product of bioethanol production. If the carbon dioxide used in the process is from a renewable source then the process may be net negative with regard to CO₂ emissions. However, even use of a source of carbon dioxide from a fossil source that otherwise would have been directly emitted means that the process may not result in any excess emission of CO². An alternative means of providing carbon dioxide is to preheat the reducing gas prior to introduction into the direct reduction shaft using oxy-fuel combustion of biomass. The principle of oxy-fuel combustion is simple: the biomass is combusted using essentially pure oxygen as the oxidant. The resulting flue stream consists essentially of carbon dioxide and steam. The steam may be removed by simple condensation, providing an essentially pure source of carbon dioxide. Conventionally, the provision of essentially pure oxygen is an economic impediment to the utilization of oxy-fuel combustion. However, in the present case there may be a ready supply of oxygen available at low additional cost from water electrolysis, making oxy-fuel preheating of the reduction gas economically feasible.

A carburizing gas may be introduced, either into the reducing zone of the direct reduction shaft as make-up gas, or lower in the reactor (such as in the isobaric zone, or the cooling/carburizing cone). The carburizing gas may be any gas known or expected in the art to provide carburization. Gas in this respect refers to a substance that is gaseous at the high temperatures prevailing in the carburization reactor, although it may be liquid or solid at room temperature. Suitable carburizing gases include hydrocarbons such as methane, natural gas, LPG or petroleum, or other carbonaceous substances such as syngas, lower (C1-C6) alcohols, esters and ethers. The carburizing gas may be of fossil origin, but it is preferable that it is obtained partly or wholly from a renewable source in order to reduce net CO₂ emissions. By renewable it is meant a resource that is naturally replenished on a human timescale. The high utilization of carbon present in the carburizing gas permits use of renewable carburizing gases, despite their relative scarcity and high cost as compared to fossil equivalents. Suitable renewable carburizing gases include biomethane, biogas, gas obtained from the pyrolysis or partial combustion of biomass (e.g., bio-syngas), lower alcohols or ethers such as methanol, DME or ethanol derived from renewable feedstocks, or combinations thereof. Sulfur-containing carburizing gases may be used, as the Sulfur is known to prevent nucleation of graphite and passivate the sponge iron product.

The composition of the carburizing gas may be chosen to suit the final carburized sponge iron to be obtained. The carburization reaction with hydrocarbons is relatively endothermic, leading to a relatively cool final product, whereas the reaction with CO-containing carburizing gases is more exothermic, leading to a hotter final product. This effect may be utilized to tailor the temperature of the final product obtained. For example, if a hot product is desired for briquetting (HBI), a gas comprising some partially oxidized carbon (e.g., in the form of CO, ketones, aldehydes) may be used, whereas if cold sponge iron (CDRI) is desired then biomethane may be used.

Inert gases such as nitrogen or purified flue gas may be used in some operations. Nitrogen may be obtained for example by cryogenic distillation of air using an air separator unit (ASU). By purified flue gas, it is meant flue gas that has been treated to ensure that it is suitable for use as a sufficiently inert gas. Such treatment may include post-combustion to remove excess oxygen, and/or drying of the flue gas.

### EMBODIMENTS

The invention will now be described in more detail with reference to certain exemplifying embodiments and the drawings. However, the invention is not limited to the exemplifying embodiments discussed herein and/or shown in the drawings, but may be varied within the scope of the appended claims. Furthermore, the drawings shall not be considered drawn to scale as some features may be exaggerated in order to more clearly illustrate certain features.

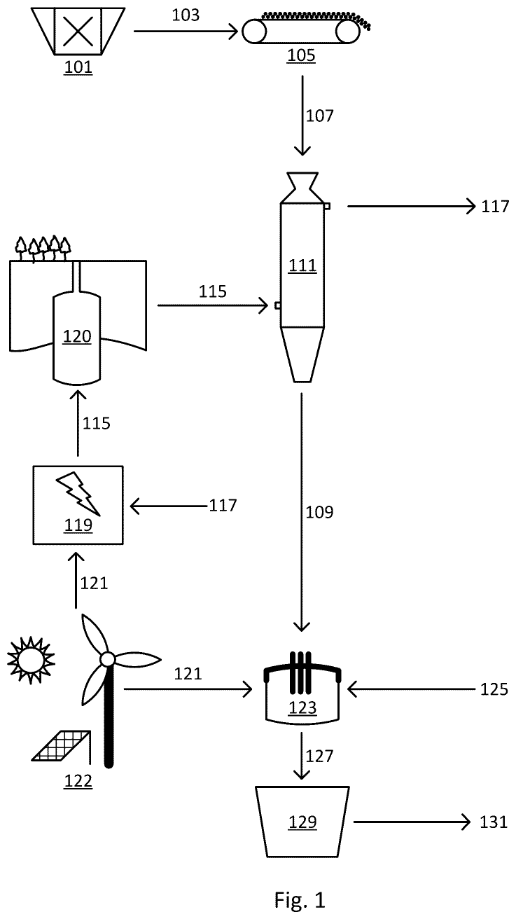

FIG. 1 schematically illustrates a prior art embodiment of the ore-based steelmaking value chain according to the Hybrit concept. The ore-based steelmaking value chain starts at the iron ore mine 101. After mining, iron ore 103 is concentrated and processed in a pelletizing plant 105, and iron ore pellets 107 are produced. These pellets, together with any lump ore used in the process, are converted to sponge iron 109 by reduction in a direct reduction shaft 111 using hydrogen gas 115 as the main reductant and producing water 117 as the main by-product. The hydrogen gas 115 is produced by electrolysis of water 117 in an electrolyser 119 using electricity 121 that is preferably primarily derived from fossil-free or renewable sources 122. The hydrogen gas 115 may be stored in a hydrogen storage 120 prior to introduction into the direct reduction shaft 111. The sponge iron 109 is melted using an electric arc furnace 123, optionally together with a proportion of scrap iron 125 or other iron source, to provide a melt 127. The melt 127 is subjected to further downstream secondary metallurgical processes 129, and steel 131 is produced. It is intended that the entire value-chain, from ore to steel may be fossil-free and produce only low or zero carbon emissions.

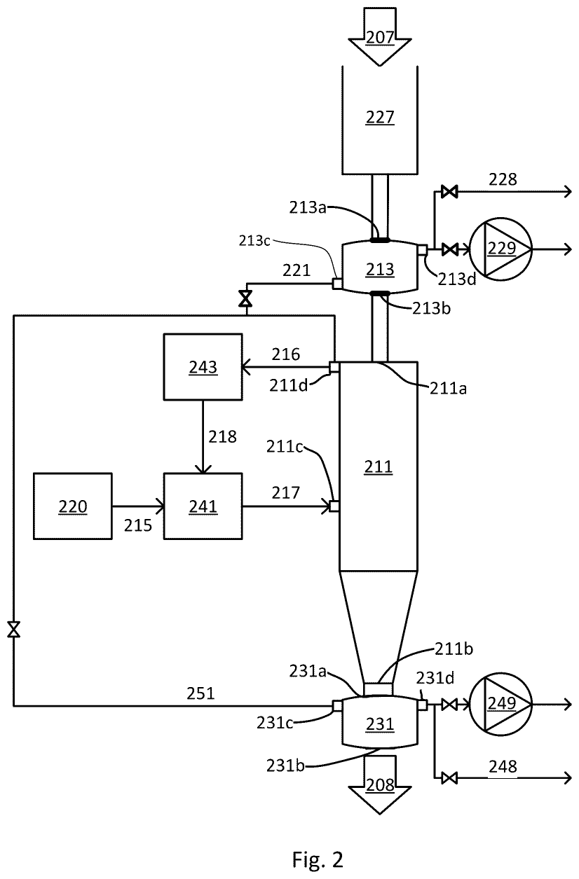

FIG. 2 schematically illustrates an exemplifying embodiment of a system suitable for performing the processes as disclosed herein.

A direct reduction shaft 211 is arranged with an inlet 211a for iron ore 207, an outlet 211b for discharging sponge iron 208, an inlet for reducing gas 211c and an outlet for top gas 211d. A charging vessel 213 is arranged in communication with the inlet 211a to the direct reduction shaft 211. A discharging vessel 231 is arranged in communication with the outlet 211b of the direct reduction shaft 211.

The charging vessel 213 comprises an inlet 213a for iron ore 207, an outlet 213b for iron ore 207, a gas inlet 213c and a gas outlet 213d. The inlet 213a of the charging vessel 213 is arranged in communication with an ore bin 227. The gas inlet 213c of the charging vessel 213 is arranged in communication with the top gas outlet 211d of the direct reduction shaft 211, via gas transfer conduit 221. The gas outlet 213d is arranged in communication with a vacuum pump 229, and is further arranged in communication with a vent line 228.

The discharging vessel 231 comprises an inlet 231a for sponge iron 208, an outlet 231b for sponge iron 208, a gas inlet 231c, and a gas outlet 231d. The inlet 231a of the discharging vessel 231 is arranged in communication with the outlet 211b of the direct reduction shaft 211. The gas inlet 231c of the charging vessel 231 is arranged in communication with the top gas outlet 211d of the direct reduction shaft 211, via gas transfer conduit 251. The gas outlet 231d is arranged in communication with a vacuum pump 249, and is further arranged in communication with a vent line 248.

Initially, ore inlet 213a and vent line 228 of the charging vessel 213 are open, and ore outlet 213b and gas inlet 213c are closed. Iron ore 207 from ore bin 227 is introduced into the charging vessel 213. Once loaded with ore, the ore inlet 213a and vent line 228 are sealed, the valve to vacuum pump 229 is opened, and the charging vessel 213 is evacuated of air, decreasing the pressure in the charging vessel 213 to about 100 mbar or less. Once the target pressure is reached, the valve to vacuum pump 229 is closed, the gas transfer line from top gas outlet 211d to gas inlet 213c is opened, and the charging vessel 213 is pressurized with top gas 216 to a pressure approximating the operating pressure of the direct reduction shaft 211. Once pressurized, the ore outlet 213b of the charging vessel 213 is opened to allow iron ore 207 to be charged to the inlet 211a of the direct reduction shaft 211. The iron ore 207 charged to the direct reduction shaft 211 progressively passes through the shaft to be discharged at outlet 211b. During its passage through the shaft 211 the ore 207 is reduced by reducing gas 217 in a counter-current flow, such that sponge iron 208 is obtained at the discharge outlet 211b of the reactor 211.

Prior to discharging the sponge iron 208, the discharging vessel 231 is first sealed at its inlet 231a and outlet 231b, evacuated using vacuum pump 249, and re-filled with top gas 216 using gas transfer line 251. The vessel 231 is then ready to receive sponge iron 208. The inlet 231a of the vessel is opened, allowing sponge iron 208 to fall into the vessel. The inlet 231a of the discharging vessel and gas transfer line 251 to the discharging vessel are then closed, the discharging vessel 231 is evacuated using vacuum pump 229, and refilled to atmospheric pressure using vent line 248. The outlet 231b of the discharging vessel 231 may then be opened to release sponge iron 208.

Make-up gas 215 is supplied from a source of make-up gas 220, such as a hydrogen gas store or water electrolyser. The make-up gas 215 is mixed with treated top gas 218 to form reducing gas 217. The reducing gas 217 is passed through a pre-heater 241 prior to introduction into the direct reduction shaft 211. The top gas 216 exiting outlet 211d is passed through a plurality of treatment apparatuses 243 in order to prepare the gas for re-introduction to the DR shaft 211. The plurality of treatment apparatuses may include a cleaning step, such as passage through an electrostatic precipitator to remove solids from the gas, heat exchange with other process gases such as the reducing gas 217, and separation of water. The treated top gas 218 is mixed with the make-up gas 215 and passed through the pre-heater 241 prior to reintroduction into the direct reduction shaft 211 through inlet 211c. The temperature of the gases entering inlet 211c may be further increased by partial oxidation. In such a case, a supply of oxygen (not shown) may be arranged between the pre-heater 241 and inlet 211c.

Once ore is discharged from the charging vessel 213, the vessel may be prepared for a new charge of ore. First, the ore outlet 213b is closed. Subsequently, process gases are evacuated from the charging vessel 213 using vacuum pump 229. The charging vessel is then refiled with a gas to ambient pressure. In the illustrated example, the vessel 213 is refilled with air via vent line 228. Finally, the ore inlet 213a is opened to receive a further charge of iron ore.

Although illustrated as extending from top gas outlet 211d, one or both of the gas transfer conduit(s) 221, 251 may instead extend from another point in the process gas circuit, such as the line carrying top gas 216 or the line carrying treated top gas 218. Although illustrated as partially integrated, gas transfer conduits 221, 251 may be fully separated lines.

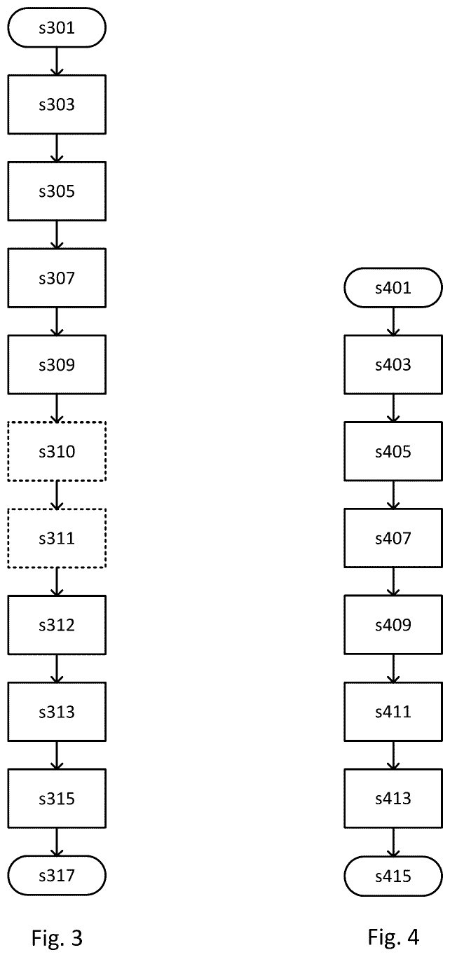

FIG. 3 is a flow chart schematically illustrating an exemplifying embodiment of the process for charging iron ore to a direct reduction shaft as disclosed herein. Step s301 denotes the start of the process. In step s303 ore outlet 213b of ore charging vessel 213 is set in a sealed state. In step s305 an ore inlet 213a of the ore charging vessel 213 is set in an open state. Note that if the ore outlet 213b and ore inlet 213a are already in a closed and open state respectively, then these steps do not involve any change in state of the charging arrangement. In step s307 the ore charging vessel 213 is charged with iron ore 207 via the ore inlet 213a. In step s309 the ore inlet 213a is set in a sealed state. In step s312, gas is evacuated from the ore charging vessel 213 by application of vacuum. In step s313, the ore charging vessel is refilled with a with process gas from the direct reduction shaft, such as top gas 216. In step s315, the ore outlet 213b is set in an open state to charge iron ore 207 to the direct reduction shaft 211. Step s317 denotes the end of the process.

The listed steps are preformed sequentially, but there may be intervening steps. For example, if for some reason the vacuum applicable to the charging vessel is not sufficient to remove substantially all air, e.g., if the charge vessel does not tolerate such low pressures, one or more extra evacuation/refill cycles may be performed between steps s309 and s312. One such evacuation/refill cycle is illustrated in FIG. 3. This involves a step s310 of evacuating gas from the ore charging vessel 213 by application of vacuum, and a step s311 of refilling the ore charging vessel with an inert gas.

FIG. 4 is a flow chart schematically illustrating an exemplifying embodiment of the process for discharging iron ore from a direct reduction shaft as disclosed herein. Step s401 denotes the start of the process. In step s403 the iron outlet 231a and the iron inlet 231b of the iron discharging vessel 231 are set in a sealed state. Note that if the outlet 231b and inlet 231a are already in a closed state, then these steps do not involve any change in state of the discharging arrangement. In step s405 gas is evacuated from the iron discharging vessel 231 by application of vacuum. In step s407, the iron charging vessel 231 is refilled with a process gas from the direct reduction shaft, such as top gas 216. In step s409, the iron inlet 231a of the iron discharging vessel 231 is set in an open state. In step s409, the iron discharging vessel 231 is charged with sponge iron 208 via the iron inlet 231a. In step s411, the iron inlet is set in a sealed state. In this manner, sponge iron 208 is discharged from the direct reduction shaft 211. Via a number of optional intermediate steps (not shown) the discharging vessel is prepared for release of the sponge iron 208. In a final step, s413, the iron outlet 231b is opened and the sponge iron 208 is released. Step s415 denotes the end of the process. The listed steps are preformed sequentially, but there may be intervening steps. For example, if for some reason the vacuum applicable to the discharging vessel is not sufficient to remove substantially all air, e.g., if the discharge vessel does not tolerate such low pressures, one or more extra evacuation/refill cycles may be performed between steps s403 and s405 (not shown).

1. An arrangement for charging iron ore to a direct reduction shaft, the arrangement comprising:
an ore charging vessel;
a direct reduction shaft;
a process gas circuit of the direct reduction shaft;
a source of vacuum; and
a gas transfer conduit arranged to extend between the ore charging vessel and the direct reduction shaft or the process gas circuit;
wherein the source of vacuum is arranged in controllable fluid communication with the ore charging vessel; and
wherein the ore charging vessel is arranged in controllable fluid communication with the direct reduction shaft or a process gas circuit thereof via the gas transfer conduit.

2. The arrangement according to claim 1, wherein the ore charging vessel comprises a sealable ore inlet and a sealable ore outlet, and wherein the gas transfer conduit comprises a controllable valve.

3. The arrangement according to claim 1, further comprising a vent line arranged in controllable fluid communication with the ore charging vessel.

4. The arrangement according to claim 1, further comprising a source of an inert gas, wherein the source of the inert gas is arranged in controllable fluid communication with the ore charging vessel.

5. The arrangement according to claim 4, wherein the inert gas is selected from the list consisting of carbon dioxide, nitrogen, purified flue gas, and combinations thereof.

6. The arrangement according to claim 1, configured to be able to attain a pressure of about 100 mbar or less in the ore charging vessel at normal temperature.

7. An arrangement for discharging sponge iron from a direct reduction shaft, the arrangement comprising:
a sponge iron discharging vessel;
a direct reduction shaft;
a process gas circuit of the direct reduction shaft;
a source of vacuum; and
a gas transfer conduit arranged to extend between the sponge iron discharging vessel and the direct reduction shaft or the process gas circuit;
wherein the source of vacuum is arranged in controllable fluid communication with the iron discharging vessel; and
wherein the sponge iron discharging vessel is arranged in controllable fluid communication with the direct reduction shaft or a process gas circuit thereof via the gas transfer conduit.

8. A system for the production of sponge iron, the system comprising:
an arrangement for charging iron ore according to claim 1; and
a source of a make-up gas arranged in fluid communication with the direct reduction shaft.

9. The system according to claim 8, wherein the source of make-up gas is an electrolyser and the make-up gas is hydrogen.

10. A process for charging iron ore to a direct reduction shaft, the process comprising the steps:
a) setting an ore outlet of an ore charging vessel in a sealed state;
b) setting an ore inlet of the ore charging vessel in an open state;
c) charging the ore charging vessel with iron ore via the ore inlet;
d) setting the ore inlet in a sealed state;
e) evacuating gas from the ore charging vessel by application of vacuum;
f) refilling the ore charging vessel with process gas from the direct reduction shaft; and
g) setting the ore outlet in an open state to charge iron ore to the direct reduction shaft.

11. The process according to claim 10, further comprising the steps:
h) setting the ore outlet in a sealed state;
i) removing a process gas from the ore charging vessel by venting and/or application of vacuum;
j) refilling the ore charging vessel with a gas selected from air, inert gas, and combinations thereof; and
k) setting the ore inlet in an open state.

12. A process for discharging sponge iron from a direct reduction shaft, the process comprising the steps:
i) setting an iron outlet and an iron inlet of an iron discharging vessel in a sealed state;
ii) evacuating gas from the iron discharging vessel by application of vacuum;
iii) refilling the iron charging vessel with process gas from the direct reduction shaft;
iv) setting an iron inlet of the iron discharging vessel in an open state;
v) charging the iron discharging vessel with sponge iron via the iron inlet; and
vi) setting the iron inlet in a sealed state.

13. A process for direct reduction of iron ore, wherein the process comprises introducing process gas from direct reduction to a direct reduction shaft in conjunction with charging the iron ore to the direct reduction shaft and/or in conjunction with discharging a sponge iron from the direct reduction shaft.

14. The process according to claim 13, wherein the process gas from direct reduction is introduced by a process for charging iron ore, the process comprising the steps:
a) setting an ore outlet of an ore charging vessel in a sealed state;
b) setting an ore inlet of the ore charging vessel in an open state;
c) charging the ore charging vessel with iron ore via the ore inlet;
d) setting the ore inlet in a sealed state;
e) evacuating gas from the ore charging vessel by application of vacuum;
f) refilling the ore charging vessel with process gas from the direct reduction shaft; and
g) setting the ore outlet in an open state to charge iron ore to the direct reduction shaft.

15. A system for the production of sponge iron, the system comprising:
an arrangement for discharging sponge iron according to claim 7; and
a source of a make-up gas arranged in fluid communication with the direct reduction shaft.

16. The process according to claim 13, wherein the process gas from direct reduction is introduced by a process for discharging sponge iron, the process comprising the steps:
i) setting an iron outlet and an iron inlet of an iron discharging vessel in a sealed state;
ii) evacuating gas from the iron discharging vessel by application of vacuum;
iii) refilling the iron charging vessel with process gas from the direct reduction shaft;
iv) setting an iron inlet of the iron discharging vessel in an open state;
v) charging the iron discharging vessel with sponge iron via the iron inlet; and
vi) setting the iron inlet in a sealed state.
